(19) United States
(12) Patent Application Publication
(10) Pub. No.: US 2025/0381784 A1
(43) Pub. Date: Dec. 18, 2025

(54) PRINTED SHEET CUTTING DEVICE FOR PRINTER

(71) Applicant: HWASUNG SYSTEM CO., LTD., Gyeonggi-do (KR)

(72) Inventor: Jin Tae KIM, Gyeonggi-do (KR)

(21) Appl. No.: 19/146,932

(22) PCT Filed: Jan. 22, 2024
(86) PCT No.: PCT/KR2024/001008

§ 371 Date: Jul. 10, 2025

(30) Foreign Application Priority Data
Jan. 27, 2023 (KR) 10-2023-0010748

(51) Int. Cl. B41J 11/70; B26D 1/22; B41J 2/32; B41J 11/00

(52) U.S. Cl. CPC B41J 11/706; B26D 1/225; B41J 2/32; B41J 11/0015

(57) ABSTRACT

This printing paper cutting device for a printer is installed on a printer so as to cut printing papers which have finished printing, and comprises: a fixed blade (51) fixed to the printer (1); and a movable blade (52) installed on the printer to be able to reciprocate such that same moves toward the fixed blade by means of a driving means, thereby cutting printing papers while overlapping the fixed blade. The fixed blade (51) comprises: a plate-shaped fixed blade body portion (511) fixed to the printer (1); an inclined portion (513) inclined from the plane of the fixed blade body portion (511); and a fixed blade cutter portion (512) formed along the front end of the inclined portion (513). The movable blade (52) comprises: a plate-shaped movable blade body portion (521) installed on the printer (1); an inclined portion (523) inclined from the plane of the movable blade body portion (521); and a movable blade cutter portion (522) formed along the front end of the inclined portion (523). The plane on which the fixed blade cutter portion (512) and the movable blade cutter portion (522) overlap is spaced apart from the plane of the fixed blade body portion (511) and the plane of the movable blade body portion (521).

### CROSS-REFERENCE TO RELATED APPLICATION

This patent application is a national stage application of PCT/KR2024/001008 filed on Jan. 22, 2024, which claims the priority and benefits of Korean patent application No. 10-2023-0010748, filed on Jan. 27, 2023, the disclosure of which is incorporated herein by reference in its entirety.

### TECHNICAL FIELD

The present disclosure relates to a printing paper cutting device for printers, and more particularly, to a printing paper cutting device for printers, which may prevent an adhesive applied to printing paper from accumulating in an overlapping region between a movable blade and a fixed blade, and a printer using the printing paper cutting device.

### BACKGROUND ART

Generally, for example, as a printer for printing documents, a type of printer may be used in which standardized paper (for example, A4, B4, etc.) is loaded into a paper tray (cassette) and stored in a main body of the printer to supply printing paper sheet by sheet. As a printer for printing labels, invoices, and the like, a type of printer may be used in which roll-type printing paper is continuously supplied, and cut into unit lengths and discharged after printing is completed.

In the latter printer (hereinafter referred to as a “label printer”), printing paper used therein is a type of paper having an adhesive applied to a rear surface, and information such as a product name, price, barcode, and expiration date, or information for shipping such as business names (or names), addresses, and phone numbers of a sender and a recipient is printed on a front surface thereof and then output. The printed labels or invoices are attached to products or shipping boxes for use.

Label or invoice paper used in the label printer is stored in a rolled state either inside a main body of the printer or in a paper supply component provided outside the main body of the printer, and the printing paper is transported by a paper feeding unit by a set length and supplied to a printing unit.

The printing paper on which printing has been completed by the printing unit is discharged to an output slot of the printer by a driving roller, and then cut by a cutter.

Typically, a cutter mounted in a label printer is configured such that a movable blade, which is movably installed in a main body of the printer and moved by a moving component, engages with a fixed blade fixed to the main body of the printer to cut printing paper, as in a cutting module for printers disclosed in Korean Patent No. 10-1282299.

### DISCLOSURE

### Technical Problem

However, in the label printer 800 disclosed in Korean Patent No. 10-1282299, as illustrated in FIGS. 1 and 2, the cutting module of the label printer is configured such that a movable blade 801 and a fixed blade 802 engage with each other to cut label paper. As a result, a portion of an adhesive applied on a rear surface of the label paper adheres to the movable blade or the fixed blade, causing a problem in which the adhesive accumulates in an engagement region between the movable blade and the fixed blade. Furthermore, a main body of the movable blade 801 and a main body of the fixed blade 802 come into surface contact with each other when the movable blade 801 and the fixed blade 802 engage with each other. Therefore, in the case where an adhesive accumulates in the engagement region between the movable blade and the fixed blade, the accumulated adhesive may bond the main body of the movable blade and the main body of the fixed blade to each other. As a result, a load required for forward movement of the movable blade increases, so that the movable blade cannot smoothly perform a reciprocating motion. Accordingly, a problem may occur in which the printing paper is not properly cut or is not discharged, causing a paper jam.

In addition, in the cutter of the label printer 800 disclosed in Korean Patent No. 10-1282299, a guillotine-type configuration is employed in which the movable blade reciprocates linearly with respect to the fixed blade, and a blade edge 803 of the movable blade 801 is formed of a pair of inclined blades arranged in a substantially V-shape with bilateral symmetry. In this case, a problem may occur in which, as the movable blade moves toward the fixed blade, engagement regions between left and right portions of the movable blade and the fixed blade converge toward a center 804 of the V-shaped blade edge 803, and an adhesive accumulated in the engagement region between the movable blade and the fixed blade is collected at the center 804 of the V-shaped blade edge 803. Furthermore, another problem may occur in which a cutting line formed by the left inclined blade and a cutting line formed by the right inclined blade are not aligned in a straight line.

Korean Patent No. 10-2210910, which was registered in the name of the applicant of the present disclosure, discloses a cutting unit 900 of a printer configured to prevent malfunction of a cutter and paper jams caused by accumulation of an adhesive applied to printing paper in a label printer. However, as illustrated in FIGS. 3 and 4, even in the cutting unit 900 of the printer disclosed in Korean Patent No. 10-2210910, a main body of a movable blade 901 and a main body of a fixed blade 902 come into surface contact with each other. Accordingly, an adhesive accumulated in an engagement region between the movable blade and the fixed blade increases a load required for forward movement of the movable blade, thereby causing a problem in which the movable blade cannot smoothly perform a reciprocating motion. Furthermore, because a blade edge 903 of the movable blade 901 is formed of a pair of inclined blades arranged in a substantially V-shape with bilateral symmetry, a problem may occur in which an adhesive accumulated in an engagement region between the movable blade 901 and the fixed blade 902 is collected at a center 904 of the V-shaped blade edge 903 of the movable blade 901. Furthermore, another problem may occur in which a cutting line formed by the left inclined blade and a cutting line formed by the right inclined blade are not aligned in a straight line.

The present disclosure has been made in an effort to solve the above problems, and an object of the present disclosure is to provide a printing paper cutting device for printers and a printer using the printing paper cutting device, in which a plane in which a blade fixed edge and a movable blade edge overlap each other is spaced apart from a plane of a fixed blade body and/or a plane of a movable blade body, thereby preventing an adhesive of printing paper from accumulating on the fixed blade body and the movable blade body.

Furthermore, an object of the present disclosure is to provide a printing paper cutting device for printers and a printer using the printing paper cutting device, in which one of opposite ends of a movable blade edge of a movable blade is retracted from a fixed blade edge of a fixed blade so that the movable blade edge of the movable blade is inclined downward to one side from a horizontal line, thereby facilitating discharge of an adhesive accumulated between the movable blade and the fixed blade, and enabling a cutting line of printing paper to be aligned in a straight line.

However, the objects are merely exemplary and are not intended to limit the scope of the present disclosure.

### Technical Solution

According to an embodiment of the present disclosure, a printing paper cutting device for printers may be installed in a printer and configured to cut printing paper on which printing is completed, and may include: a fixed blade fixed to the printer; and a movable blade installed to be reciprocable in the printer and configured to move toward the fixed blade by a driving unit and cut the printing paper while overlapping the fixed blade. The fixed blade may include a plate-shaped fixed blade body fixed to the printer, an inclined portion inclined from a plane of the fixed blade body, and a fixed blade edge formed along a leading edge of the inclined portion. The movable blade may include a plate-shaped movable blade body installed in the printer, an inclined portion inclined from a plane of the movable blade body, and a movable blade edge formed along a leading edge of the inclined portion. A plane in which the fixed blade edge and the movable blade edge overlap each other may be spaced apart from each of the plane of the fixed blade body and the plane of the movable blade body.

According to a modification of the embodiment of the present disclosure, a printing paper cutting device for printers may be installed in a printer and configured to cut printing paper on which printing is completed, and may include: a fixed blade fixed to the printer; and a movable blade installed to be reciprocable in the printer and configured to move toward the fixed blade by a driving unit and cut the printing paper while overlapping the fixed blade. The fixed blade may include a plate-shaped fixed blade body fixed to the printer, and a fixed blade edge formed along a leading edge of the fixed blade body. The movable blade may include a plate-shaped movable blade body installed in the printer, an inclined portion inclined from a plane of the movable blade body, and a movable blade edge formed along a leading edge of the inclined portion. A plane in which the fixed blade edge and the movable blade edge overlap each other may be spaced apart from the plane of the movable blade body.

According to another modification of the embodiment of the present disclosure, a printing paper cutting device for printers may be installed in a printer and configured to cut printing paper on which printing is completed, and may include: a fixed blade fixed to the printer; and a movable blade installed to be reciprocable in the printer and configured to move toward the fixed blade by a driving unit and cut the printing paper while overlapping the fixed blade. The fixed blade may include a plate-shaped fixed blade body fixed to the printer, an inclined portion inclined from a plane of the fixed blade body, and a fixed blade edge formed along a leading edge of the inclined portion. The movable blade may include a plate-shaped movable blade body installed in the printer, and a movable blade edge formed along a leading edge of the movable blade body. A plane in which the fixed blade edge and the movable blade edge overlap each other may be spaced apart from the plane of the fixed blade body.

According to an embodiment of the present disclosure, a printing paper cutting device for printers may be installed in a printer and configured to cut printing paper on which printing is completed, and may include: a fixed blade fixed to the printer; and a movable blade installed to be reciprocable in the printer and configured to move toward the fixed blade by a driving unit and cut the printing paper while overlapping the fixed blade. The fixed blade may include a plate-shaped fixed blade body fixed to the printer, an inclined portion inclined from a plane of the fixed blade body, and a fixed blade edge formed along a leading edge of the inclined portion. The movable blade may include a plate-shaped movable blade body installed in the printer, and a movable blade edge inclined such that one end of opposite widthwise ends thereof is positioned farther from the fixed blade edge compared to a remaining end of the opposite ends. A plane in which the fixed blade edge and the movable blade edge overlap each other may be spaced apart from the plane of the fixed blade body.

According to an embodiment of the present disclosure, a printing paper cutting device for printers may be installed in a printer and configured to cut printing paper on which printing is completed, and may include: a fixed blade fixed to the printer; and a movable blade installed to be reciprocable in the printer and configured to move toward the fixed blade by a driving unit and cut the printing paper while overlapping the fixed blade. The fixed blade may include a plate-shaped fixed blade body fixed to the printer, and a fixed blade edge inclined such that one end of opposite widthwise ends thereof is positioned farther from a movable blade edge compared to a remaining end of the opposite ends. The movable blade may include a plate-shaped movable blade body installed in the printer 1, an inclined portion inclined from a plane of the movable blade body, and the movable blade edge formed along a leading edge of the inclined portion. A plane in which the fixed blade edge and the movable blade edge overlap each other may be spaced apart from the plane of the movable blade body.

In the printing paper cutting device according to an embodiment of the present disclosure, the fixed blade may be disposed in a vertical direction in the printer. The movable blade may be disposed in a vertical direction in the printer, and configured to move upward and downward by the driving unit, and to move upward toward the fixed blade by the driving unit such that the fixed blade edge and the movable blade edge overlap each other.

In the printing paper cutting device according to an embodiment of the present disclosure, the inclined portion of the fixed blade may include a first inclined portion and a second inclined portion, and a first angle formed between the first inclined portion and the fixed blade body may be greater than a second angle formed between the second inclined portion and the fixed blade body.

In the printing paper cutting device according to an embodiment of the present disclosure, a guide piece protruding to be inclined in a direction away from the fixed blade may be formed on an end of the opposite widthwise ends of the movable blade edge, the end protruding toward the fixed blade edge.

In the printing paper cutting device according to an embodiment of the present disclosure, an inclination angle formed between the inclined portion of the movable blade and the movable blade body may range from about 10° to 25°.

In the printing paper cutting device according to an embodiment of the present disclosure, the first angle formed between the first inclined portion of the fixed blade and the fixed blade body may range from about 50° to 90°. The second angle formed between the second inclined portion of the fixed blade and the fixed blade body may range from about 3° to 7° .

In the printing paper cutting device according to an embodiment of the present disclosure, an inclination angle formed with respect to a horizontal line by configuring the one end of the movable blade edge to be positioned farther from the fixed blade edge compared to the remaining end may range from about 2.5° to 7.5°.

In the printing paper cutting device according to an embodiment of the present disclosure, an inclination angle formed by configuring the one end of the fixed blade edge to be positioned farther from the movable blade edge compared to the remaining end may range from about 2.5° to 7.5°.

In the printing paper cutting device according to an embodiment of the present disclosure, the fixed blade edge of the fixed blade may form an angle ranging from about 0.3° to 0.7° with the movable blade edge of the movable blade such that the movable blade edge of the movable blade engages with the fixed blade edge of the fixed blade and then moves away from the fixed blade edge of the fixed blade, so that an adhesive may be prevented from accumulating between the fixed blade edge of the fixed blade and the movable blade edge of the movable blade.

A printer according to an embodiment of the present disclosure may use any one of the printing paper cutting devices described above.

In the printer according to an embodiment of the present disclosure, one or more adhesive discharge outlets may be formed in an upper right portion of a partition plate located below the fixed blade edge on a side at which the one end of the opposite widthwise ends of the movable blade edge is positioned farther from the fixed blade edge compared to the remaining end.

In the printer according to an embodiment of the present disclosure, an adhesive discharge guide configured to guide an adhesive to be discharged outside a printer housing may be attached to the adhesive discharge outlets.

### Advantageous Effects

According to a printing paper cutting device for printers in accordance with present disclosure configured as described above, a plane in which a fixed blade edge and a movable blade edge overlap each other is spaced apart from a plane of a fixed blade body and/or a plane of a movable blade body, thereby preventing an adhesive of printing paper from accumulating on the fixed blade body and the movable blade body.

According to the printing paper cutting device for printers in accordance with present disclosure, one end of opposite ends of the movable blade edge is positioned farther from the fixed blade edge compared to a remaining end, such that the movable blade edge is inclined downward to one side from a horizontal line. The aforementioned configuration facilitates discharge of adhesive accumulating between the movable blade and the fixed blade, and allows a cutting line of the printing paper to be aligned in a straight line.

However, the foregoing effects are merely illustrative and do not limit the scope of the present disclosure.

### BRIEF DESCRIPTION OF DRAWINGS

FIG. 1 is a longitudinal sectional view of a label printer including a cutting module to which a guillotine-type blade unit is applied, according to a conventional art.

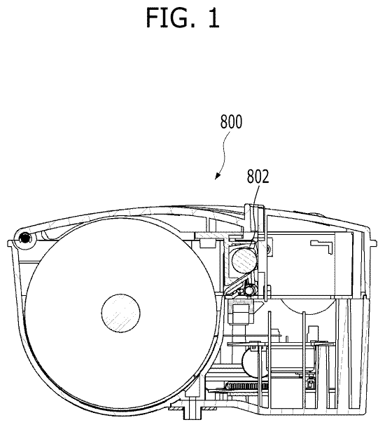

FIG. 2 is a partially exploded perspective view illustrating a configuration of the cutting module of the label printer of FIG. 1.

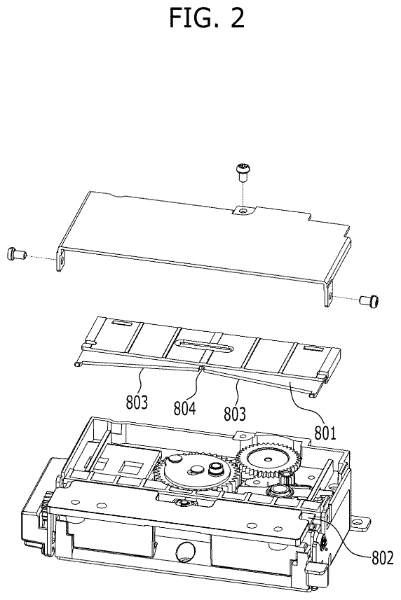

FIG. 3 is an exploded perspective view of a cutting unit of a label printer according to another conventional art.

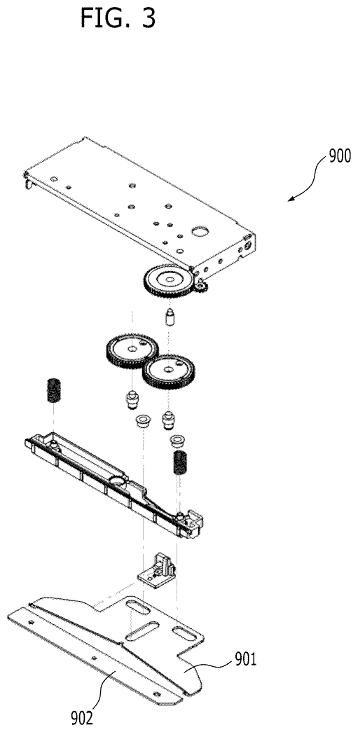

FIG. 4 is a view illustrating an engaged state between a fixed blade and a movable blade of the cutting unit of the label printer of FIG. 3.

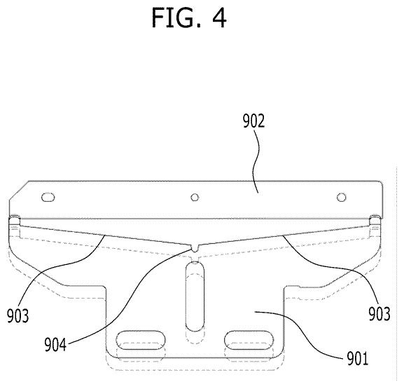

FIG. 5 is a perspective view illustrating a printer to which a printing paper cutting device for printers according to an embodiment of the present disclosure is applied.

FIG. 6 is a perspective view illustrating a state in which an upper housing is removed from the printer of FIG. 5.

FIG. 7 is a perspective view of the printer of FIG. 6 as viewed from a cutting device.

FIG. 8 is a longitudinal sectional view of a printer to which a printing paper cutting device for printers according to an embodiment of the present disclosure is applied.

FIG. 9 is an enlarged view illustrating the cutting device shown in FIG. 8.

FIG. 10 is an exploded perspective view of a movable blade unit of the cutting device shown in FIG. 8.

FIG. 11 is a view illustrating the assembled movable blade unit of FIG. 10.

FIG. 12 is a view illustrating a vertical arrangement of a fixed blade and a movable blade in the printing paper cutting device for printers according to an embodiment of the present disclosure.

FIG. 13 is a perspective view illustrating an arrangement of the fixed blade and the movable blade in the printing paper cutting device for printers according to an embodiment of the present disclosure.

FIG. 14 is a view illustrating a configuration of the fixed blade and the movable blade in the printing paper cutting device for printers according to an embodiment of the present disclosure.

FIG. 15 is a view illustrating an engaged relationship between the fixed blade and the movable blade in the printing paper cutting device for printers according to an embodiment of the present disclosure.

FIG. 16 is a view illustrating a vertical arrangement of the fixed blade and the movable blade in the printing paper cutting device for printers according to an embodiment of the present disclosure.

FIG. 17a is a perspective view illustrating an engaged state between the fixed blade and the movable blade at a time point when the movable blade begins to move upward toward the fixed blade in the printing paper cutting device for printers according to an embodiment of the present disclosure.

FIG. 17b is a perspective view illustrating an engaged state in which the movable blade moves upward toward the fixed blade and engages with the fixed blade at an intermediate point of the fixed blade, in the printing paper cutting device for printers according to an embodiment of the present disclosure.

FIG. 18 is a plan view illustrating an engaged state between the fixed blade and the movable blade as viewed from above in the printing paper cutting device for printers according to an embodiment of the present disclosure.

FIG. 19 is a view illustrating an adhesive discharge outlet formed below the fixed blade in the printer according to an embodiment of the present disclosure.

### BEST MODE

The aforementioned object, features, and advantages of the present disclosure will be clearer through the following embodiments associated with the accompanying drawings.

The following specific structure or functional explanations are illustrated only to describe embodiments in accordance with the concept of the present disclosure. The embodiments in accordance with the concept of the present disclosure may be embodied in various forms but are not interpreted to be limited to the embodiments described in this specification or application.

Various modifications may be applied to the embodiments in accordance with the concept of the present disclosure and the embodiments may have various forms so that the specific embodiments will be described in detail in the specification or the application h reference to the accompanying drawings. However, this does not limit the present disclosure within specific embodiments, and it should be understood that the present disclosure covers all the modifications, equivalents and replacements within the spirit and technical scope of the present disclosure.

Terms such as first or second may be used to describe various components but the components are not limited by the above terms. The terms are used only to distinguish one component from the other component, for example, a first component may be referred to as a second component without departing from a scope in accordance with the concept of the present disclosure and similarly, a second component may be referred to as a first component.

It should be understood that, when it is described that a component is “coupled” or “connected” to another component, the component may be directly coupled or directly connected to the other component or coupled or connected to the other component through a third component. On the contrary, it should be understood that, when a component is referred to as being “directly connected to” or “directly coupled to” another component, a third component does not intervene therebetween. Other expressions to describe the relationship between components, that is, expressions such as “between”, “immediately between”, “adjacent to”, or “directly adjacent to” need to be also similarly interpreted.

Terms used in the present specification are used only to describe specific embodiments, and are not intended to limit the present disclosure. A singular form may include a plural form if there is no clearly opposite meaning in the context. In this specification, it should be understood that the term “include” or “have” indicates that a feature, a number, a step, an operation, a component, a part of the combination thereof described in the specification is present, but does not exclude a possibility of presence or addition of one or more other features, numbers, steps, operations, components, parts or combinations thereof.

Unless otherwise defined, all terms used herein may be interpreted as having the meanings commonly understood by those skilled in the art to which the present disclosure pertains. Terms that are generally defined in dictionaries should be construed as having meanings consistent with their use in the context of the related technology, and should not be interpreted in an idealized or unduly formal sense unless expressly defined in the present specification.

Hereinafter, the present disclosure will be described in detail by describing the embodiments of the present disclosure with reference to the accompanying drawings. Like reference numerals indicated in the respective drawings refer to like components.

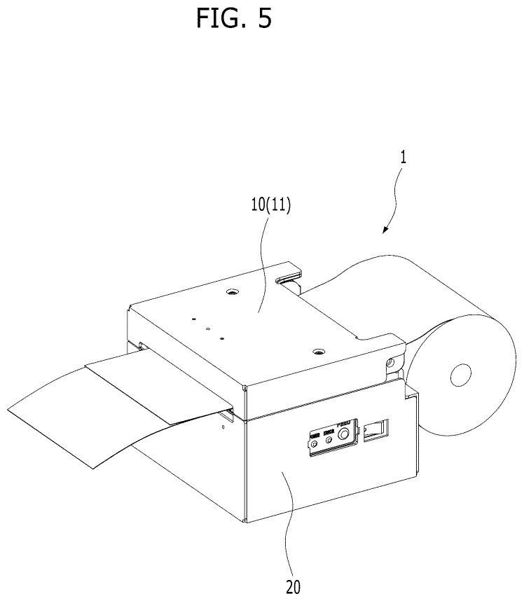

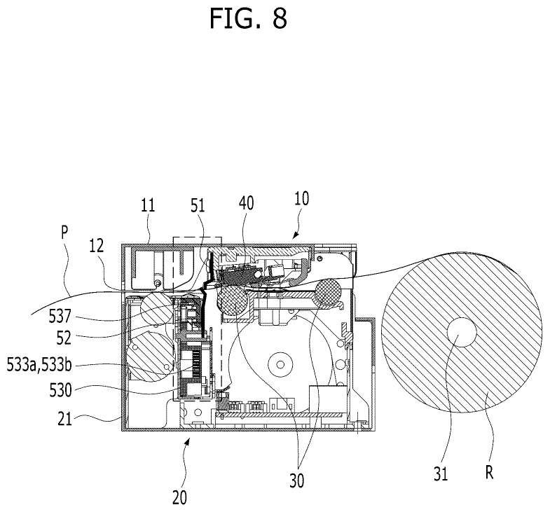

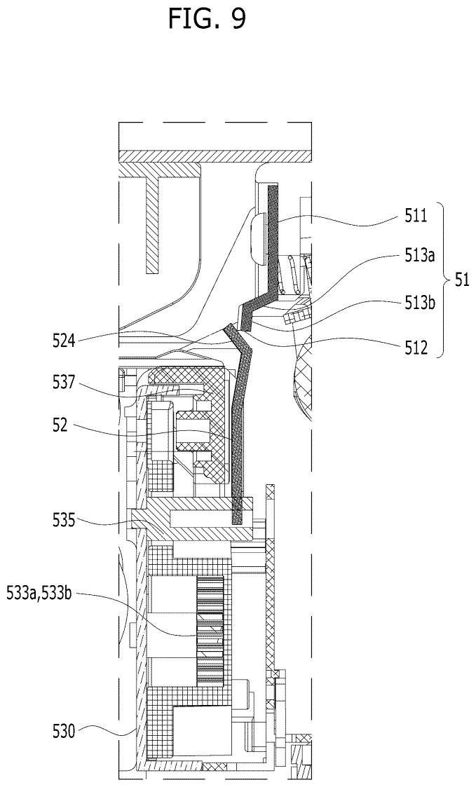

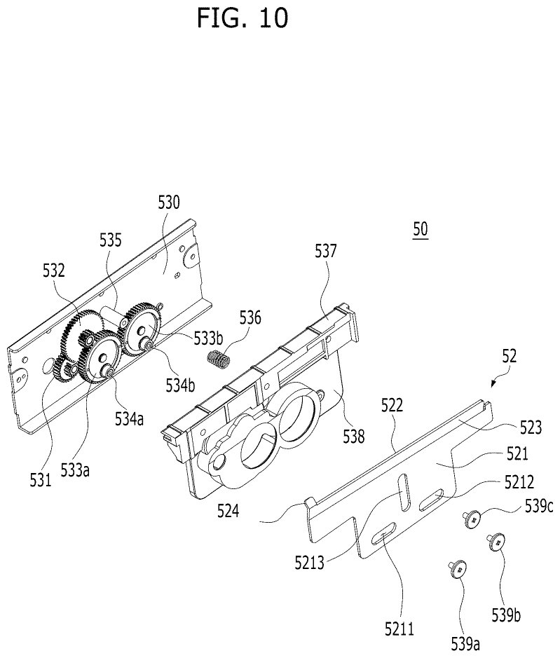

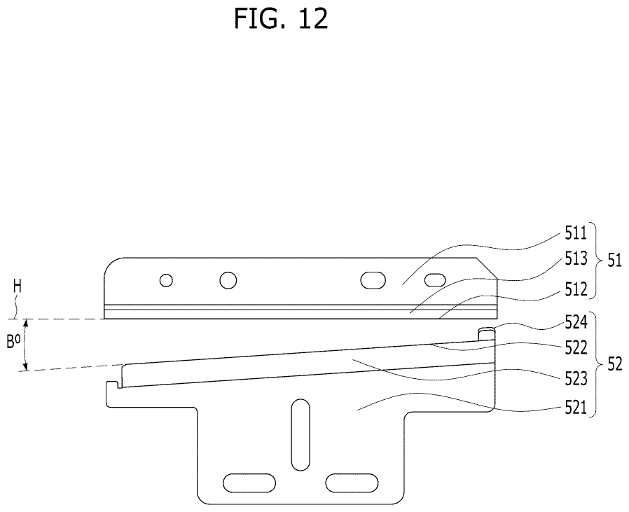

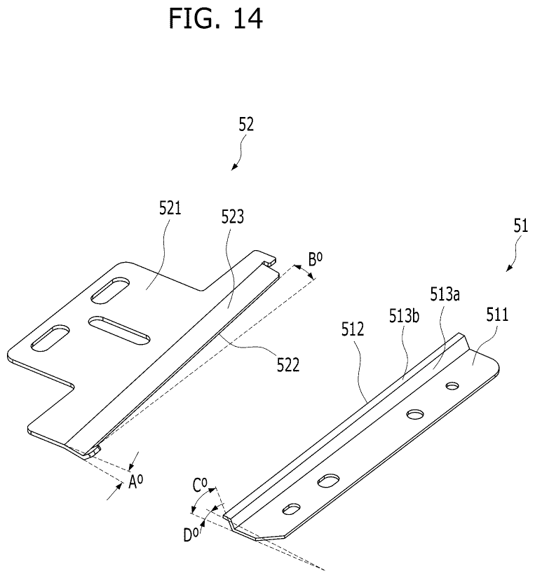

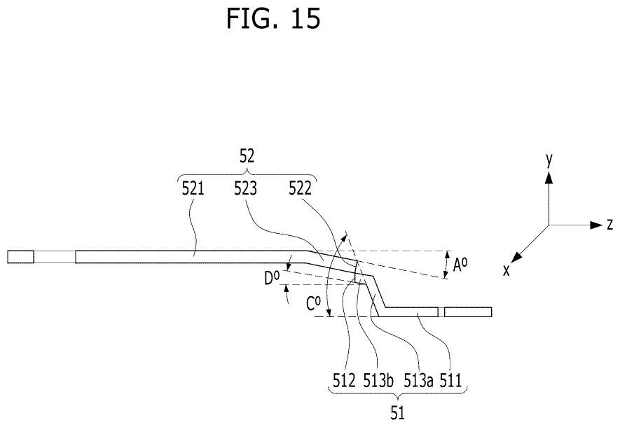

FIG. 5 is a perspective view illustrating a printer to which a printing paper cutting device for printers according to an embodiment of the present disclosure is applied. FIG. 8 is a longitudinal sectional view of a printer to which a printing paper cutting device for printers according to an embodiment of the present disclosure is applied. FIG. 9 is an enlarged view illustrating the cutting device shown in FIG. 8. FIG. 10 is an exploded perspective view of a movable blade unit of the cutting device shown in FIG. 8. FIG. 12 is a view illustrating a vertical arrangement of a fixed blade and a movable blade in the printing paper cutting device for printers according to an embodiment of the present disclosure. FIG. 14 is a view illustrating a configuration of the fixed blade and the movable blade in the printing paper cutting device for printers according to an embodiment of the present disclosure. FIG. 15 is a view illustrating an engaged relationship between the fixed blade and the movable blade in the printing paper cutting device for printers according to an embodiment of the present disclosure.

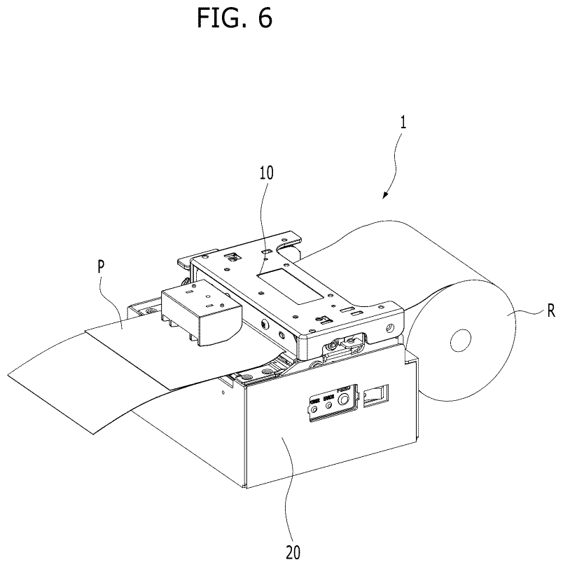

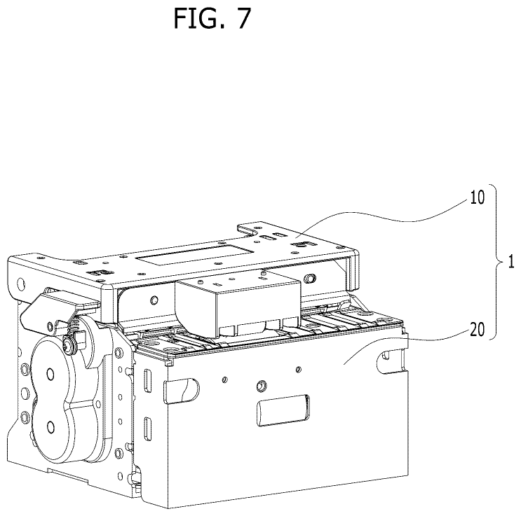

The printing paper cutting device for printers and a printer using the printing paper cutting device according to an embodiment of the present disclosure will be described with reference to FIGS. 5 to 15.

As illustrated in FIGS. 5 to 8, a printer 1 according to an embodiment of the present disclosure may include a printer body 20 and a printer cover 10. The printer cover 10 may be connected at one side thereof to the printer body 20 by a hinge (not shown), and may be fastened at another side thereof to the printer body 20 by a locking component (not shown). When the locking component of the printer body 20 and the printer cover 10 is released, the printer cover 10 may be rotated with respect to the printer body 20 to open an upper portion of the printer body 20.

The printer 1 according to an embodiment of the present disclosure may include, as main components, a paper feeding unit 30, a printing unit 40, a cutting device, and a driving unit. The main components, such as the paper feeding unit 30, the printing unit 40, the cutting device, and the driving unit, may be installed in the printer body 20 and/or the printer cover 10.

Referring to FIG. 8, the printer body 20 may be formed in a housing shape having an upper portion that is substantially open. Components such as the paper feeding unit, a movable blade unit, the driving unit, and a control unit may be installed in the printer body 20. Components such as the fixed blade and the printing unit may be installed in the printer cover 10, which is openable and closable in a hinge manner on the upper portion of the printer body 20. However, the configuration of the printer 1 is not limited thereto. The printer 1 may be configured as follows: the movable blade unit may be installed in the printer cover 10, the fixed blade may be installed in the printer body 20, the printing unit may be installed in the printer body 20, and the control unit may be installed in the printer cover 10.

In FIGS. 5, 6, and 8, in the printer 1 according to an embodiment of the present disclosure, a printing paper supply roll R is rotatably installed outside the printer body 20. However, the present disclosure is not limited thereto. For example, the printing paper supply roll R may be implemented in various forms as long as the printing paper supply roll R has a structure capable of continuously supplying printing paper in a roll form, such as being installed inside the printer body 20.

Printing paper P has one surface serving as a printing surface on which information is printed, and a remaining surface serving as an adhesive surface on which an adhesive is applied to allow attachment to an article. After labels, invoices, or the like are printed thereon by the printing unit 40, the printing paper P is cut by the cutting device.

The printing paper P may be formed, for example, of thermal paper that reacts to heat and may be printed by a thermal writing method using a thermal head.

In addition, the printing paper P may be configured as a linerless type in which no release liner is provided on the adhesive-applied surface. Alternatively, a separate release liner may be attached to an upper surface of the adhesive, and the release liner may be removed after the printing paper is cut by the cutting device.

As illustrated in FIGS. 5 and 8, an upper housing 11 may be openably coupled to an upper end of the printer body 20 and to the printer cover 10. A paper outlet 12 may be provided between a lower end of the upper housing 11 and an upper end of one side of the printer body 20, so that the printing paper P that is cut after printing is completed can be discharged to the outside of the printer through the paper outlet 12. The paper outlet 12 may be formed in the one side of the printer body 20.

The paper feeding unit 30 is a component configured to transport the printing paper P while allowing label or invoice information to be printed on one surface of the printing paper P, and to feed the printing paper P, on which printing has been completed, toward the cutting device of the printer.

As illustrated in FIG. 8, the paper feeding unit 30 maintains the printing paper P in close contact with a thermal head of the printing unit 40 and, under the control of the control unit, rotates to draw the printing paper P from the paper supply roll R that is rotatably provided on a winding roller 31 installed outside the printer body 20, and transports the printing paper P toward the cutting device.

The printing unit 40 is a component configured to print label or invoice information, such as characters, numbers, symbols, or figures, on the printing surface of the printing paper P, and may be implemented in various forms depending on a printing method.

For example, the printing unit 40 may be configured as a thermal head that converts electrical energy into thermal energy, and may generate heat under the control of the control unit and write information on the printing paper P by applying the heat to the printing paper P, which thermally reacts to the heat.

Furthermore, the printing unit 40 may employ a known printing technology such as an inkjet printing method or a laser printing method, and a detailed description thereof will be omitted.

The cutting device is a component configured to cut the printing paper P on which printing has been completed by the printing unit 40.

The printing paper cutting device for printers according to an embodiment of the present disclosure may be configured in a guillotine type in which a movable blade 52 and a fixed blade 51 are separately provided, and the movable blade 52 performs a linear reciprocating motion. Specifically, the cutting device according to the embodiment of the present disclosure includes the fixed blade 51 fixed to the printer 1, and the movable blade 52 that is installed to be reciprocally movable with respect to the printer, is moved by a driving unit, and cuts the printing paper while moving toward the fixed blade by the driving unit and overlapping with the fixed blade. As illustrated in FIG. 8, the cutting device may be oriented in a vertical direction. For example, the fixed blade 51 may be vertically installed in the printer cover 10, and the movable blade 52 may be vertically installed in the printer body 20 below the fixed blade 51. In the aforementioned arrangement, the movable blade 52 may move vertically by the driving unit (not shown), and may be moved upward toward the fixed blade 51 by the driving unit so that a fixed blade edge 512 of the fixed blade and a movable blade edge 522 of the movable blade overlap each other, thereby cutting the printing paper P positioned between the fixed blade 51 and the movable blade 52.

As illustrated in FIGS. 12 and 14, in the printing paper cutting device for printers according to an embodiment of the present disclosure, a guide piece 524 that protrudes to be inclined in a direction away from the fixed blade 51 may be formed on an end of the movable blade edge 522 of the movable blade 52, the end being one of opposite widthwise ends and protruding toward the fixed blade edge 512. The guide piece 524 first comes into contact with the fixed blade edge 512 of the fixed blade 51 as the movable blade 52 moves upward, and guides the movable blade edge 522 of the movable blade 52 to overlap with the fixed blade edge 512 of the fixed blade 51, thereby enabling smooth cutting of the printing paper P.

In the embodiment of FIG. 8, the cutting device is configured such that the fixed blade 51 is installed in the printer cover 10 and the movable blade 52 is installed in the printer body 20. However, the cutting device may also be configured such that the fixed blade 51 is installed in the printer body 20 and the movable blade 52 is installed in the printer cover In addition, although in the embodiment illustrated in FIG. 8 the fixed blade 51 and the movable blade 52 are arranged vertically, the cutting device may also be configured such that the fixed blade 51 and the movable blade 52 are arranged horizontally.

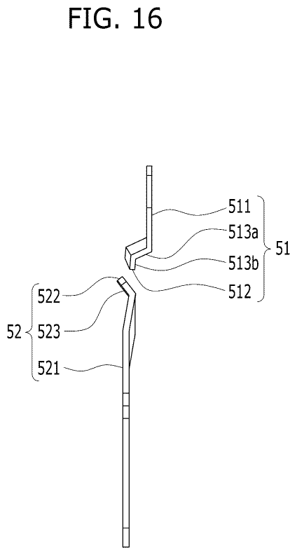

As illustrated in FIGS. 9 and 14 to 16, the fixed blade 51 includes a plate-shaped fixed blade body 511 fixed to the printer cover 10, an inclined portion 513 inclined from a plane of the fixed blade body 511, and a fixed blade edge 512 formed along a leading edge of the inclined portion 513. In FIG. 15, an x-direction represents a width direction of the fixed blade 51, which corresponds to a direction crossing the printing paper P. A y-direction represents a front-rear direction of the fixed blade 51, which corresponds to a direction in which the printing paper P is transported. A z-direction represents a vertical direction of the fixed blade 51, which corresponds to a direction in which the movable blade 52 reciprocates with respect to the fixed blade 51. The inclined portion is formed to have a predetermined width in a direction perpendicular to the fixed blade edge 512 of the fixed blade 51. With the aforementioned configuration, as illustrated in FIG. 15, the fixed blade edge 512 is positioned at a distance spaced toward the movable blade 52 from the fixed blade body 511. Accordingly, when the movable blade 52 engages and overlaps with the fixed blade 51, contact between the fixed blade body 511 and a movable blade body 521 is prevented. As a result, accumulation of adhesive of the printing paper P on the fixed blade body 511 and the movable blade body 521 is prevented, thereby enabling smooth vertical reciprocating motion of the movable blade, and preventing problems such as failure to properly cut the printing paper or jamming of the printing paper.

In the printing paper cutting device for printers according to an embodiment of the present disclosure, the inclined portion 513 of the fixed blade 51 may include a first inclined portion 513a and a second inclined portion 513b. A first angle C° formed between the first inclined portion 513a and the fixed blade body 511 may be set to be greater than a second angle D° formed between the second inclined portion 513b and the fixed blade body 511. With this configuration, a distance by which the fixed blade edge 512 is spaced from the fixed blade body 511 toward the movable blade 52 may be increased, thereby more effectively preventing the adhesive of the printing paper P from accumulating on the fixed blade body 511 and the movable blade body 521. In this case, the first angle C° formed between the first inclined portion 513a of the fixed blade 51 and the fixed blade body 511 may range from about 50° to 90°. In the case where the first angle C° is equal to or smaller than about 50°, the effect of spacing the fixed blade edge 512 from the fixed blade body 511 is reduced. In the case where the first angle C° is equal to or larger than about 90°, the fixed blade edge 512 may face in a direction opposite to the movable blade edge 522 of the movable blade. The second angle D° formed between the second inclined portion 513b of the fixed blade 51 and the fixed blade body 511 may be set in a range ranging from about 3° to 7°. In the case where the second angle D° is equal to or smaller than about 3°, the effect of spacing the fixed blade edge 512 from the fixed blade body 511 is reduced. In the case where the second angle D° is equal to or larger than about 7°, engagement with the movable blade edge 522 may not be reliable.

As illustrated in FIGS. 9 and 14 to 16, the movable blade 52 includes a plate-shaped movable blade body 521 installed in the printer body 20, an inclined portion 523 inclined from a plane of the movable blade body 521, and a movable blade edge 522 formed along a leading edge of the inclined portion 523. In FIG. 15, an x-direction represents a width direction of the movable blade 52, which corresponds to a direction crossing the printing paper P. A y-direction represents a front-rear direction of the movable blade 52, which corresponds to a direction in which the printing paper P is transported. A z-direction represents a vertical direction of the movable blade 52, which corresponds to a direction in which the movable blade 52 reciprocates with respect to the fixed blade 51. The inclined portion has a predetermined width in a direction perpendicular to the movable blade edge 522 of the movable blade 52. With this configuration, as illustrated in FIG. 15, the movable blade edge 522 is positioned at a position spaced apart from the movable blade body 521 toward the fixed blade 51 by a predetermined distance. Accordingly, when the movable blade 52 engages and overlaps with the fixed blade 51, contact between the movable blade body 521 and the fixed blade body 511 is prevented. As a result, accumulation of adhesive of the printing paper P on the movable blade body 521 and the fixed blade body 511 is prevented, thereby enabling smooth vertical reciprocating motion of the movable blade, and preventing problems such as improper cutting of the printing paper or jamming of the printing paper.

In this case, an inclination angle A° formed between the inclined portion 523 of the movable blade 52 and the movable blade body 521 may be set in a range from about 10° to 25°. In the case where the inclination angle A° is equal to or smaller than about 10°, the effect of spacing the movable blade edge 522 from the movable blade body 521 is reduced. In the case where the inclination angle A° equal to or larger than about 25°, engagement with the fixed blade edge 512 may not be reliable.

In the printing paper cutting device for printers according to an embodiment of the present disclosure described above, the fixed blade 51 includes the inclined portion 513 that is inclined from the plane of the fixed blade body 511 and extends by a predetermined length in the front-rear direction (x-direction). The movable blade 52 includes the inclined portion 523 that is inclined from a plane of the movable blade body 521 and extends by a predetermined length in the front-rear direction (x-direction. As a result, a plane in which the fixed blade edge 512 formed on the inclined portion 513 of the fixed blade and the movable blade edge 522 formed on the inclined portion 523 of the movable blade overlap each other is spaced apart from each of the plane of the fixed blade body 511 and the plane of the movable blade body 521.

In a modification of the printing paper cutting device for printers according to an embodiment of the present disclosure, the fixed blade 51 includes a fixed blade edge 512 formed along a leading edge of a fixed blade body 511, and the movable blade 52 includes a movable blade edge 522 formed along a leading edge of an inclined portion 523 that is inclined from a plane of a movable blade body 521 and extends by a predetermined length in the front-rear direction (x-direction). Accordingly, the printing paper cutting device may be configured such that a plane in which the fixed blade edge 512 of the fixed blade and the movable blade edge 522 of the movable blade overlap each other may be spaced apart from the plane of the movable blade body 521.

With this configuration, the fixed blade edge 512 of the fixed blade 51 is positioned at a position spaced from the movable blade body 521 of the movable blade 52 by a predetermined distance. Accordingly, when the movable blade 52 engages and overlaps with the fixed blade 51, contact between the fixed blade body 511 and the movable blade body 521 is prevented. As a result, accumulation of adhesive of the printing paper P on the fixed blade body 511 and the movable blade body 521 is prevented, thereby enabling smooth vertical reciprocating motion of the movable blade and preventing problems such as failure to properly cut the printing paper or jamming of the printing paper.

Furthermore, in another modification of the printing paper cutting device for printers according to an embodiment of the present disclosure, the fixed blade 51 includes a fixed blade edge 512 formed along a leading edge of an inclined portion 513 that is inclined from a plane of a fixed blade body 511 and extends by a predetermined length in the front-rear direction (x-direction), and the movable blade 52 includes a movable blade edge 522 formed along a leading edge of a movable blade body 521. Accordingly, the printing paper cutting device may be configured such that a plane in which the fixed blade edge 512 of the fixed blade and the movable blade edge 522 of the movable blade overlap each other may be spaced apart from the plane of the fixed blade body 511. With this configuration, the movable blade edge 522 of

the movable blade 52 is positioned at a position spaced apart from the fixed blade body 511 of the fixed blade 51 by a predetermined distance. Accordingly, when the movable blade 52 engages and overlaps with the fixed blade 51, contact between the fixed blade body 511 and the movable blade body 521 is prevented. As a result, accumulation of adhesive of the printing paper P on the fixed blade body 511 and the movable blade body 521 may be prevented, thereby allowing the movable blade t to perform smoothly a vertical reciprocating motion, and preventing problems such as failure to properly cut the printing paper or jamming of the printing paper.

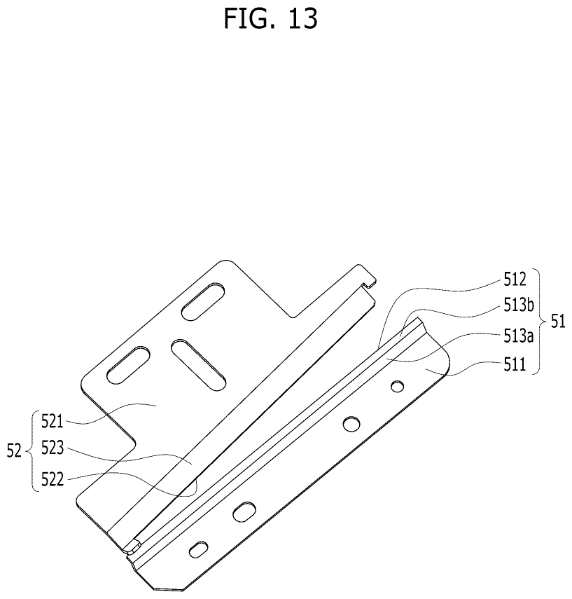

According to an embodiment of the present disclosure, one end of opposite widthwise ends of the movable blade edge 522 of the movable blade 52 may be positioned farther from the fixed blade edge 512 compared to a remaining one of the opposite ends. For example, as shown in FIGS. 12 and 13, the movable blade edge 522 of the movable blade 52 may be inclined such that one end (left end) of the opposite widthwise ends thereof is positioned farther downward from the fixed blade edge 512 compared to a remaining end (right end). In other words, the movable blade edge 522 of the movable blade may be formed to be inclined downward toward one side with respect to a horizontal line H. Here, an inclination angle B°, formed by configuring one end of the movable blade edge 522 of the movable blade to be positioned farther from the fixed blade edge 512 of the fixed blade compared to the remaining end, may be set in a range from about 2.5° to 7.5°. In the case where the inclination angle B° is equal to or smaller than about 2.5°, the effect of sweeping away the accumulated adhesive is reduced. In the case where the inclination angle B° is equal to or larger than about 7.5°, the distance of reciprocating movement of the movable blade 52 becomes excessively large. With this configuration, as illustrated in FIG. 12, the movable blade edge 522 of the movable blade 52 is inclined downward toward the left. Therefore, when the movable blade 52 moves upward, the right end of the movable blade edge 522 first engages with the fixed blade 51, and the engagement point moves from the right end toward the left end of the movable blade edge 522. Accordingly, when the movable blade 52 engages with the fixed blade 51 to cut the printing paper P, adhesive generated during the cutting process can be swept and pushed toward the left end of the movable blade edge of the movable blade, thereby facilitating the discharge of adhesive that may otherwise accumulate between the movable blade 52 and the fixed blade 51. As a result, problems such as failure to properly cut the printing paper or jamming of the printing paper can be prevented.

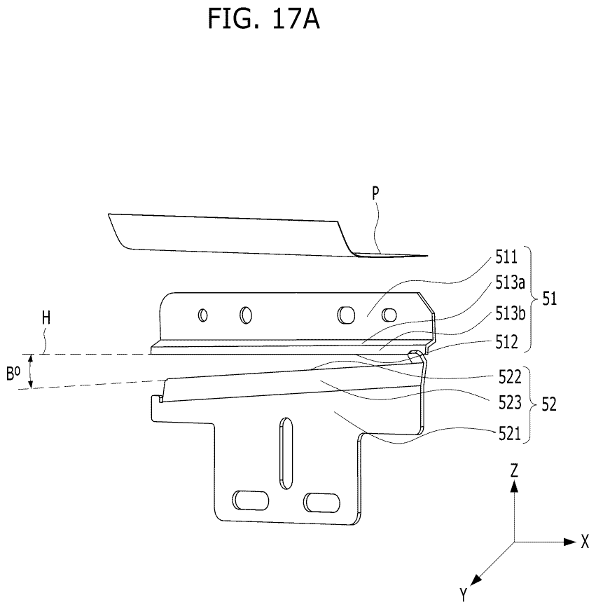

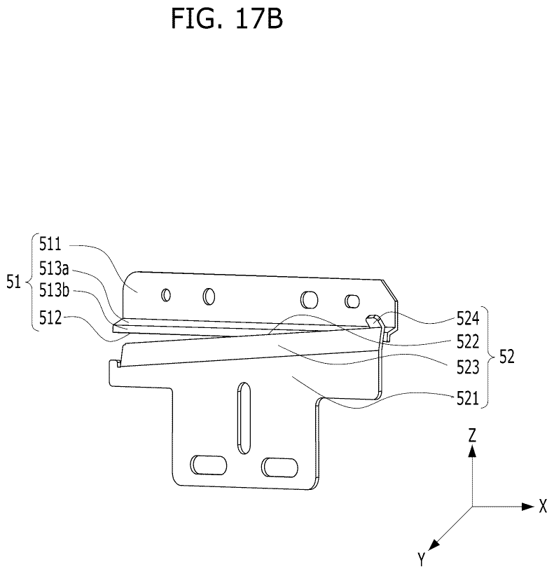

Referring to FIGS. 17a and 17b, the printing paper cutting device for printers according to an embodiment of the present disclosure will be described, in which the movable blade edge 522 of the movable blade 52 is inclined downward relative to the horizontal line H. As illustrated in FIG. 17a, in the printing paper cutting device for printers, the movable blade 52 begins to move upward (in the z-direction) toward the fixed blade 51, and the engagement between the fixed blade and the movable blade begins from the right side (in the x-direction). As the movable blade 52 continues to move upward, the fixed blade edge 512 sweeps the adhesive accumulated on the movable blade edge 522 in a left-downward direction (downward in the z-direction), thereby preventing the adhesive from accumulating on the movable blade edge 522. FIG. 17b illustrates a state in which the movable blade 52 moves upward toward the fixed blade 51 (in the z-direction) and engages the fixed blade 51 at an intermediate point thereof in the printing paper cutting device for printers. As such, as the engagement point between the movable blade edge 522 and the fixed blade edge 512 moves to the left (in the x-direction), the adhesive may be swept in the left-downward direction (downward in the z-direction).

In addition, in a printing paper cutting device for printers according to the conventional art, where the movable blade edge of the movable blade is formed to have a bilaterally symmetrical structure in a substantially V-shape, a cutting line of printing paper formed by the left inclined blade and a cutting line of the printing paper formed by the right inclined blade may not be aligned in a straight line. In contrast, according to an embodiment of the present disclosure, because the movable blade edge 522 of the movable blade 52 is formed as a single blade edge inclined to one side in the width direction, a cutting line of the printing paper formed by the movable blade edge of the movable blade may be formed in a straight line.

According to a modification of an embodiment of the present disclosure, the fixed blade edge 512 of the fixed blade 51 may be formed such that one end of opposite widthwise ends of the fixed blade edge 512 is positioned farther from the movable blade edge 522 compared to a remaining one of the opposite ends. For example, although not illustrated, the fixed blade edge 512 of the fixed blade 51 may be inclined such that one end (left end) of the opposite widthwise ends thereof is positioned farther upward from the movable blade edge 522 compared to a remaining end (right end). In other words, the fixed blade edge 512 may be formed to be inclined upward toward one side with respect to the horizontal line H. Here, an inclination angle B°, formed by configuring one end of the fixed blade edge 512 to be positioned farther from the movable blade edge 512 compared to the remaining end, may be set in a range from about 2.5° to 7.5°. The operational effect in this case is similar to that of the case where the movable blade edge 522 is inclined downward to one side with respect to the horizontal line H, and thus a detailed description thereof will be omitted.

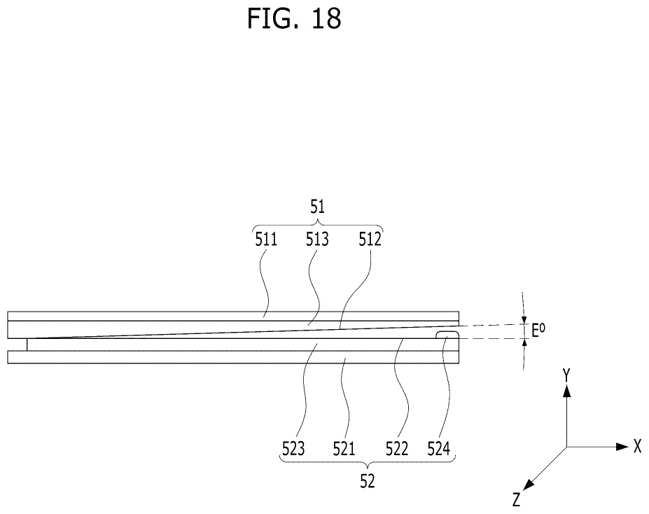

As illustrated in FIG. 18, in the printing paper cutting device for printers according to an embodiment of the present disclosure, the fixed blade edge 512 of the fixed blade may be installed to form an angle E° in a range from about 0.3° to 0.7° with respect to the movable blade edge 522 of the movable blade. In the printing paper cutting device for printers according to an embodiment of the present disclosure, it is desirable that, when the engaged state between the fixed blade and the movable blade is viewed from above, the right side of the inclined portion 513 of the fixed blade be formed to be more distant rearward (in the y-direction) from the inclined portion 523 of the movable blade compared to the left side. In other words, it is desirable that the right end of the inclined portion 513 of the fixed blade be spaced farther apart from the inclined portion 523 of the movable blade compared to the left end thereof. With this configuration, after the movable blade edge 522

of the movable blade 52 engages with the fixed blade edge 512 of the fixed blade 51, the movable blade edge 522 moves away from the fixed blade edge 512 of the fixed blade 51, thereby preventing the adhesive from accumulating between the fixed blade edge 512 of the fixed blade 51 and the movable blade edge 522 of the movable blade 52.

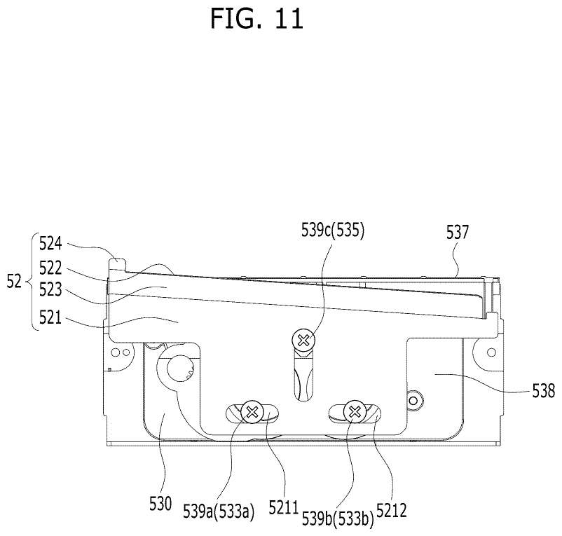

Next, a movable blade unit 50, to which the movable blade 52 in the printing paper cutting device for printers according to an embodiment of the present disclosure is coupled, will be described with reference to FIGS. 10 and 11.

The movable blade unit 50 includes the movable blade 52, a movable blade unit bracket 530, a plurality of gears 531, 532, 533a, and 533b, a gear cover 538, and a spacer 537.

An elongated vertical guide slot 5213 vertically penetrating through a central portion of the movable blade body 521 of the movable blade 52 is formed, and a pair of elongated horizontal guide slots 5211 and 5212 horizontally penetrating through both lower sides are formed in the movable blade body 521.

A plurality of gear shafts (not shown) to which the plurality of gears 531, 532, 533a, and 533b are coupled are provided on an inner surface of a movable blade unit bracket 530. A fastener 535 to be inserted into and coupled with the vertical guide slot 5213 of the movable blade 52 is installed on an upper side of a central portion of the inner surface of the movable blade unit bracket 530. An internal thread may be formed on an end of the fastener 535. The movable blade unit bracket 530 including the fastener may be made of a metallic material.

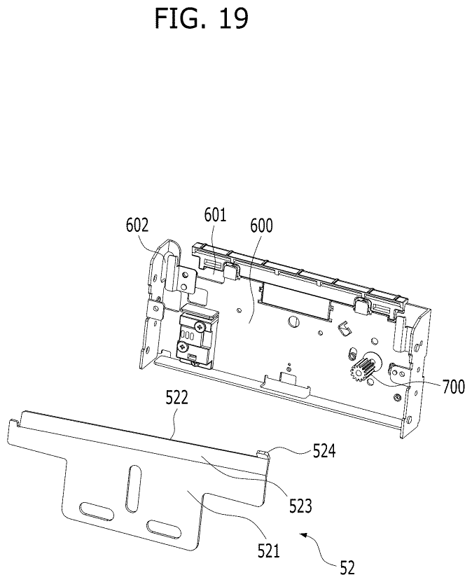

The plurality of gears may include, for example, a first gear 531, a second gear 532, a third gear 533a, and a fourth gear 533b. The first gear 531 is a gear configured to receive driving force from an input shaft 700 (see FIG. 19) of a drive motor (not shown). The second gear 532 is a gear that engages with the first gear 531 to reduce a rotational speed. The third gear 533a and the fourth gear 533b are gears that engage with the second gear 532 and rotate in directions opposite to each other. Even when the second gear 532 drives the third gear 533a and the fourth gear 533b, the rotational speed is also reduced. Protrusions (not shown) are respectively formed at eccentric positions offset by a predetermined distance from the centers on respective side surfaces of the third gear 533a and the fourth gear 533b. An internal thread may be formed on an end of each of the protrusions. Bushings 534a and 534b made of a metallic material may be fitted over and coupled to the respective protrusions. The metal bushings 534a and 534b may be freely rotatable around the protrusions of the third gear 533a and the fourth gear 533b. The plurality of gears 531, 532, 533a, and 533b may be formed of a plastic material, but are not limited thereto and may also be made of other known materials.

The gear cover 538 is configured to cover the group of gears from upper and side surfaces of the plurality of gears, thereby preventing foreign substances from entering the gears. A portion of an upper surface of the gear cover 538 is open, so that the bushings 534a and 534b, which are eccentrically coupled to the side surfaces of the third gear 533a and the fourth gear 533b, are exposed. The gear cover 538 may be made of a plastic material, but is not limited thereto and may be made of other known materials.

The spacer 537 is disposed between the movable blade 52 and an upper portion of the inner surface of the movable blade unit bracket 530, and functions to maintain a constant gap between the movable blade 52 and the movable blade unit bracket 530. A compression coil spring 536 may be installed inside the spacer 537. The spacer 537 may be made of a material more flexible than the movable blade 52 and the movable blade unit bracket 530. For example, the movable blade 52 and the movable blade unit bracket 530 may be made of a metallic material, and the spacer 537 may be made of a plastic material.

Next, assembly of the movable blade unit 50 will be described.

First, the first gear 531, the second gear 532, the third gear 533a, and the fourth gear 533b are sequentially coupled to the plurality of gear shafts installed on the inner surface of the movable blade unit bracket 530. The bushings 534a and 534b made of a metallic material are fitted over and coupled to the protrusions formed on respective side surfaces of the third gear 533a and the fourth gear 533b.

Thereafter, the gear cover 538 is disposed above the plurality of gears 531, 532, 533a, and 533b.

Subsequently, the spacer 537 is disposed above the gear cover 538, with the compression coil spring 536 placed on a central portion of an inner surface of the spacer 537.

Next, with the inclined portion 523 of the movable blade 52 facing the spacer 537, the pair of horizontal guide grooves 5211 and 5212 of the movable blade 52 are coupled to the bushings 534a and 534b provided on the protrusions formed on the respective side surfaces of the third gear 533a and the fourth gear 533b. The vertical guide groove 5213 of the movable blade 52 is coupled to the fastener 535 provided on the inner surface of the movable blade unit bracket 530. Thereafter, screws 539a, 539b, and 539c are fastened to respective ends of the bushings 534a and 534b and the end of the fastener 535.

The assembly of the movable blade unit 50 as shown in FIG. 11 may be completed through the above assembly process.

Next, a reciprocating motion of the movable blade 52 in the printing paper cutting device for printers according to an embodiment of the present disclosure will be described with reference to FIGS. 10 and 11.

In the printing paper cutting device for printers according to an embodiment of the present disclosure, the fixed blade 51 and the movable blade 52 may be arranged in either the vertical direction or the horizontal direction. In the present specification, the reciprocating motion of the movable blade 52 will be described with respect to an embodiment in which the fixed blade 51 and the movable blade 52 of the cutting device are arranged in the vertical direction.

Referring to FIG. 10, the bushings 534a and 534b, which are rotatably fitted over the respective protrusions of the third gear 533a and the fourth gear 533b, are respectively coupled to the pair of horizontal guide grooves 5211 and 5212 of the movable blade 52. According to the aforementioned configuration, rotational force from an output shaft of the drive motor (not shown) is transmitted to the first gear 531, and the rotational force of the first gear 531 is transmitted to the second gear 532. The rotational force of the second gear 532 is transmitted to the third gear 533a. Because the fourth gear 533b engages with the third gear 533a, the fourth gear 533b rotates in a direction opposite to that of the third gear 533a.

In the configuration described above, when the third gear 533a rotates counterclockwise and the fourth gear 533b rotates clockwise, the bushings 534a and 534b, which are eccentrically coupled to the third gear 533a and the fourth gear 533b, respectively, perform semicircular motions and move from the lower side to the upper side. During the aforementioned operation, the bushings 534a and 534b move away from and then approach each other within the pair of horizontal guide grooves 5211 and 5212. As a result, by the action of the bushings 534a and 534b that cause the movable blade 52 to move upward in the vertical direction relative to the fastener 535, the movable blade 52 moves upward.

On the other hand, in contrast to the upward movement of the movable blade 52 described above, when the third gear 533a rotates clockwise and the fourth gear 533b rotates counterclockwise, the bushings 534a and 534b, which are eccentrically coupled to the third gear 533a and the fourth gear 533b, respectively, perform semicircular motions and move from the upper side to the lower side. During the aforementioned operation, the bushings 534a and 534b move away from and then approach each other within the pair of horizontal guide grooves 5211 and 5212. As a result, by the action of the bushings 534a and 534b that cause the movable blade 52 to move downward in the vertical direction relative to the fastener 535, the movable blade 52 moves downward.

The printing paper cutting device for printers according to an embodiment of the present disclosure described above may be applied to a printer 1 for printing labels, invoices, and the like.

In the case where the printer 1 provided with the printing paper cutting device for printers according to an embodiment of the present disclosure is used, the plane in which the fixed blade edge 512 and the movable blade edge 522 overlap with each other in the printing paper cutting device is spaced apart from the plane of the fixed blade body 511 and/or the plane of the movable blade body 521, thereby preventing the adhesive of the printing paper from accumulating on the fixed blade body 511 and the movable blade body 521.

Furthermore, in the case where the printer 1 provided with the printing paper cutting device for printers according to an embodiment of the present disclosure is used, one end of opposite ends of the movable blade edge 522 is positioned farther from the fixed blade edge 512 in the printing paper cutting device, such that the movable blade edge 522 is inclined downward to one side with respect to the horizontal line H. The aforementioned configuration facilitates discharge of adhesive accumulated between the movable blade 52 and the fixed blade 51 and enables a cutting line of the printing paper to be aligned in a straight line.

According to an embodiment of the present disclosure, as shown in FIG. 12, the movable blade edge 522 of the movable blade 52 may be inclined downward to one side (left side in FIG. 12) with respect to a horizontal line H in the width direction. With this configuration, an adhesive generated when the movable blade 52 engages with the fixed blade 51 to cut the printing paper P may be swept downward toward the left end of the movable blade edge 522. The adhesive swept downward in the above-mentioned manner is required to be discharged to the outside of the printer 1. To this end, as illustrated in FIG. 19, one or more adhesive discharge outlets 601 and 602 may be formed in an upper left portion of a partition plate 600, which is located below the fixed blade edge 512 on the side at which one end of the opposite widthwise ends of the movable blade edge 522 is positioned farther from the fixed blade edge 512 compared to the remaining end.

Furthermore, an adhesive discharge guide (not shown), which guides the adhesive to be discharged to the outside of the printer housing, may be additionally attached to the adhesive discharge outlets 601 and 602.

Although various embodiments of the disclosure have been disclosed for illustrative purposes with reference to the drawings, those skilled in the art will appreciate that various modifications, additions and substitutions are possible, without departing from the scope and spirit of the disclosure as defined in the accompanying claims. Thus, the true technical scope of the disclosure should be defined by the following claims.

This printing paper cutting device for a printer is installed on a printer so as to cut printing papers which have finished printing, and comprises: a fixed blade (51) fixed to the printer (1); and a movable blade (52) installed on the printer to be able to reciprocate, thereby cutting printing papers while overlapping the fixed blade. The fixed blade (51) comprises: a plate-shaped fixed blade body portion (511); an inclined portion (513); and a fixed blade cutter portion (512). The movable blade (52) comprises: a plate-shaped movable blade body portion (521); an inclined portion (523); and a movable blade cutter portion (522). The plane on which the fixed blade cutter portion (512) and the movable blade cutter portion (522) overlap is spaced apart from the plane of the fixed blade body portion (511) and the plane of the movable blade body portion (521).

1. A printing paper cutting device for printers, installed in a printer (1) and configured to cut printing paper on which printing is completed, the printing paper cutting device comprising:
a fixed blade (51) fixed to the printer (1); and
a movable blade (52) installed to be reciprocable in the printer and configured to move toward the fixed blade by a driving unit and cut the printing paper while overlapping the fixed blade,
wherein the fixed blade (51) comprises a plate-shaped fixed blade body (511) fixed to the printer (1), an inclined portion (513) inclined from a plane of the fixed blade body (511), and a fixed blade edge (512) formed along a leading edge of the inclined portion (513),
wherein the movable blade (52) comprises a plate-shaped movable blade body (521) installed in the printer (1), an inclined portion (523) inclined from a plane of the movable blade body (521), and a movable blade edge (522) formed along a leading edge of the inclined portion (523), and
wherein a plane in which the fixed blade edge (512) and the movable blade edge (522) overlap each other is spaced apart from each of the plane of the fixed blade body (511) and the plane of the movable blade body (521).

2. A printing paper cutting device for printers, installed in a printer and configured to cut printing paper on which printing is completed, the printing paper cutting device comprising:
a fixed blade (51) fixed to the printer (1); and
a movable blade (52) installed to be reciprocable in the printer and configured to move toward the fixed blade by a driving unit and cut the printing paper while overlapping the fixed blade,
wherein the fixed blade (51) comprises a plate-shaped fixed blade body (511) fixed to the printer (1), an inclined portion (513) inclined from a plane of the fixed blade body (511), and a fixed blade edge (512) formed along a leading edge of the inclined portion (513),
wherein the movable blade (52) comprises a plate-shaped movable blade body (521) installed in the printer (1), and a movable blade edge (522) inclined such that one end of opposite widthwise ends thereof is positioned farther from the fixed blade edge (512) compared to a remaining end of the opposite ends, and
wherein a plane in which the fixed blade edge (512) and the movable blade edge (522) overlap each other is spaced apart from the plane of the fixed blade body (511).

3. A printing paper cutting device for printers, installed in a printer and configured to cut printing paper on which printing is completed, the printing paper cutting device comprising:
a fixed blade (51) fixed to the printer (1); and
a movable blade (52) installed to be reciprocable in the printer and configured to move toward the fixed blade by a driving unit and cut the printing paper while overlapping the fixed blade,
wherein the fixed blade (51) comprises a plate-shaped fixed blade body (511) fixed to the printer (1), and a fixed blade edge (512) inclined such that one end of opposite widthwise ends thereof is positioned farther from a movable blade edge (522) compared to a remaining end of the opposite ends,
wherein the movable blade (52) comprises a plate-shaped movable blade body (521) installed in the printer (1), an inclined portion (523) inclined from a plane of the movable blade body (521), and the movable blade edge (522) formed along a leading edge of the inclined portion (523), and
wherein a plane in which the fixed blade edge (512) and the movable blade edge (522) overlap each other is spaced apart from the plane of the movable blade body (521).

4. The printing paper cutting device according to claim 1,
wherein the fixed blade (51) is disposed in a vertical direction in the printer (1), and
wherein the movable blade (52) is disposed in a vertical direction in the printer (1), and configured to move upward and downward by the driving unit, and to move upward toward the fixed blade (51) by the driving unit such that the fixed blade edge (512) and the movable blade edge (522) overlap each other.

5. The printing paper cutting device according to claim 1, wherein the inclined portion (513) of the fixed blade comprises a first inclined portion (513a) and a second inclined portion (513b), and a first angle (C.°) formed between the first inclined portion (513a) and the fixed blade body (511) is greater than a second angle (D°) formed between the second inclined portion (513b) and the fixed blade body (511).

6. The printing paper cutting device according to claim 2, wherein a guide piece (524) protruding to be inclined in a direction away from the fixed blade (51) is formed on an end of the opposite widthwise ends of the movable blade edge (522), the end protruding toward the fixed blade edge (512).

7. The printing paper cutting device according to claim 1, wherein an inclination angle (A°) formed between the inclined portion (523) of the movable blade (52) and the movable blade body (521) ranges from about 10° to 25°.

8. The printing paper cutting device according to claim 5,
wherein the first angle (C°) formed between the first inclined portion (513a) of the fixed blade (51) and the fixed blade body (511) ranges from about 50° to 90°, and
wherein the second angle (D°) formed between the second inclined portion (513b) of the fixed blade (51) and the fixed blade body (511) ranges from about 3° to 7°.

9. The printing paper cutting device according to claim 2, wherein an inclination angle (B°), formed by configuring the one end of the movable blade edge (522) to be positioned farther from the fixed blade edge (512) compared to the remaining end, ranges from about 2.5° to 7.5°.

10. The printing paper cutting device according to claim 3, wherein an inclination angle, formed by configuring the one end of the fixed blade edge (512) to be positioned farther from the movable blade edge (522) compared to the remaining end, ranges from about 2.5° to 7.5°.

11. The printing paper cutting device according to claim 4, wherein the fixed blade edge (512) of the fixed blade forms an angle (E°) ranging from about 0.3° to 0.7° with the movable blade edge (522) of the movable blade, such that the movable blade edge (522) of the movable blade (52) engages with the fixed blade edge (512) of the fixed blade (51) and then moves away from the fixed blade edge (512) of the fixed blade (51), so that adhesive is prevented from accumulating between the fixed blade edge (512) of the fixed blade (51) and the movable blade edge (522) of the movable blade (52).

12. A printer (1) using the printing paper cutting device according to claim 1.

13. The printer (1) according to claim 12, wherein adhesive discharge outlets (601) and (602) are formed in an upper right portion of a partition plate (600) located below the fixed blade edge (512) on a side at which the one end of the opposite widthwise ends of the movable blade edge (522) is positioned farther from the fixed blade edge (512) compared to the remaining end.

14. The printer (1) according to claim 13, wherein an adhesive discharge guide configured to guide an adhesive to be discharged outside a printer housing is attached to the adhesive discharge outlets (601) and (602).

15. A printing paper cutting device for printers, installed in a printer and configured to cut printing paper on which printing is completed, the printing paper cutting device comprising:
a fixed blade (51) fixed to the printer (1); and
a movable blade (52) installed to be reciprocable in the printer and configured to move toward the fixed blade by a driving unit and cut the printing paper while overlapping the fixed blade,
wherein the fixed blade (51) comprises a plate-shaped fixed blade body (511) fixed to the printer (1), and a fixed blade edge (512) formed along a leading edge of the fixed blade body (511),
wherein the movable blade (52) comprises a plate-shaped movable blade body (521) installed in the printer (1), an inclined portion (523) inclined from a plane of the movable blade body (521), and a movable blade edge (522) formed along a leading edge of the inclined portion (523), and
wherein a plane in which the fixed blade edge (512) and the movable blade edge (522) overlap each other is spaced apart from the plane of the movable blade body (521).

16. A printing paper cutting device for printers, installed in a printer and configured to cut printing paper on which printing is completed, the printing paper cutting device comprising:
a fixed blade (51) fixed to the printer (1); and
a movable blade (52) installed to be reciprocable in the printer and configured to move toward the fixed blade by a driving unit and cut the printing paper while overlapping the fixed blade,
wherein the fixed blade (51) comprises a plate-shaped fixed blade body (511) fixed to the printer (1), an inclined portion (513) inclined from a plane of the fixed blade body (511), and a fixed blade edge (512) formed along a leading edge of the inclined portion (513),
wherein the movable blade (52) comprises a plate-shaped movable blade body (521) installed in the printer (1), and a movable blade edge (522) formed along a leading edge of the movable blade body (521), and
wherein a plane in which the fixed blade edge (512) and the movable blade edge (522) overlap each other is spaced apart from the plane of the fixed blade body (511).
